(19) United States
(12) Patent Application Publication
(10) Pub. No.: US 2008/0301545 A1
(43) Pub. Date: Dec. 4, 2008

(54) METHOD AND SYSTEM FOR THE INTELLIGENT ADAPTION OF WEB CONTENT FOR MOBILE AND HANDHELD ACCESS

(76) Inventors: Jia Zhang, DeKalb, IL (US); Stephen Yang, Jhongli City (TW)

Correspondence Address: KOHN & ASSOCIATES, PLLC, 30500 NORTHWESTERN HWY, SUITE 410, FARMINGTON HILLS, MI, 48334, US

(21) Appl. No.: 12/130,402

(22) Filed: May 30, 2008

Related U.S. Application Data
(60) Provisional application No. 60/941,595, filed on Jun. 1, 2007.

(51) Int. Cl. G06F 17/00; G06F 17/30

(52) U.S. Cl. 715/235; 707/100; 715/238; 707/E17.107; 707/E17.009

(57) ABSTRACT

According to the present invention, there is provided a novel method and system for supporting dynamic Web content adaptation in the mobile Internet, while retaining the semantic coherence of the site's original contents. This is accomplished by analyzing, processing, and displaying web content using several algorithms. While the preferred embodiment of the present invention is for use in a mobile Internet setting, the method and system of the present invention can be applied and customized for use in a broad range of settings and applications involving information layout adaptation and presentation across multiple platforms and devices.

### BACKGROUND OF THE INVENTION

1. Field of the Invention

The present invention generally relates to information technology, and, more particularly, to a method and system for adapting Web content for better presentation on mobile and handheld devices.

2. Description of Related Art

In recent years, advanced computer technologies have empowered various handheld devices such as Ultra Mobile PC (UMPC), Personal Digital Assistants (PDAs), Pocket PCs, and smart phones. However, users of these handheld devices frequently encounter presentation problems (for example, cut layouts and oversized pictures) when surfing the Internet. These problems are primarily due to the fact that most existing Web pages and applications are not originally designed for display on handheld devices. Rather, most websites are configured for presentation on full-function Web browsers running on desktop or laptop computers (PCs). Handheld devices, necessarily, possess less computational power, smaller display screens, and slower network speeds than their full-featured PC counterparts. As a result, the direct delivery and presentation of Internet content without layout adjustment (‘layout adjustment’ refers to modifying the visual display of a webpage to allow it to be displayed on an alternative device, such as a cellular phone with a small viewing screen) and content adaptation often leads to disorganized or inaccurate information portrayal on handheld screens, in addition to requiring that users constantly scroll across large areas before perceiving a complete piece of information. Currently, no tools and/or mechanisms exist in the marketplace to provide users opportunities to experience transparent and seamless Web access using either desktop computers or handheld devices.

The term ‘content adaptation’ refers to the technique of dynamically adjusting content presentation to meet the constraints of different receiving devices for better presentation. The conventional approach of providing Web content for various types of receiving devices is to prepare the same content in different formats. For example, Wireless Markup Language (WML) (OMA) was created as a format to develop Web content oriented to wireless devices. A Web page may possess both Hyper Text Markup Language (HTML) and WML versions to support desktop and handheld device presentation, respectively. This approach, while straightforward, is labor-intensive and error-prone. Content providers are required to prepare different versions of layouts for the same Web content, which results in tremendous overhead. In order to support a new device, all previous Web pages must support a new format. Even worse, any changes or updates to Web content may require consequent changes on every parallel format. This arrangement is neither practical nor feasible for providers of large volumes of Web content.

A simplistic content adaptation solution has been proposed whereby multi-column Web layouts are changed into a single-column layout for display on small handheld screens. This approach also introduces significant problems, as semantic errors may appear when adjacent media objects crosscut. Without retaining semantic coherence and relationships among semantic units, this primitive adaptation can interfere with the organization of a Web page and lead to misunderstanding.

Web content is typically composed of multimedia objects such as text, images, audio and video. These objects, carrying encapsulated meanings, are connected with each other via different relationships. For example, an image can illustrate a section of text article; a text title can abstract a text article or serve as the caption to an image. In other words, these related Web objects (e.g., text, image, and audio clip) are synergistically integrated and connected in order to present information in the most clear and illustrative way possible. In order for the presentation of the components to be effective, the semantics among presentation components must be maintained. For example, an illustrative figure should be shown close to its detailed text message or caption. When Web content is adapted for display on different devices, the semantics of the decomposed portions in the adapted contents should ideally remain the same as those in the original content. Improper rearrangement and/or presentation of these objects and their relationships may lead to ambiguous or misunderstood expression or loss of information. Ideally, adapted objects should be grouped and presented based on semantic consistency. Therefore, it is important for a content adaptation mechanism to maintain the original site's semantic structure among the various objects during an adaptation process.

### SUMMARY OF THE INVENTION

The present invention provides a novel method and system for supporting dynamic Web content adaptation in the mobile Internet, while retaining the semantic coherence of the site's original contents. This is accomplished by analyzing, processing, and displaying web content using several algorithms. While the preferred embodiment of the present invention is for use in a mobile Internet setting, the method and system of the present invention can be applied and customized for use in a broad range of settings and applications involving information layout adaptation and presentation across multiple platforms and devices.

### DESCRIPTION OF THE DRAWINGS

Other advantages of the present invention will be readily appreciated, as the same becomes better understood by reference to the following detailed description when considered in connection with the accompanying drawings wherein:

FIG. 1 is a flow chart illustrating exemplary phases of a dynamic content adaptation process, according to one aspect of the present invention;

FIG. 2 is a block diagram illustrating an exemplary hierarchical representation of content structure model, according to another aspect of the invention;

FIG. 3 is an exemplary block diagram illustrating exemplary relationships between Web pages, segments, and object clusters, according to another aspect of the invention;

FIG. 4 is an exemplary block diagram illustrating an exemplary hierarchical representation of a segment tree, according to another aspect of the invention;

FIG. 5 is an exemplary textual representation of an algorithm of constructing a segment tree, according to another aspect of the invention;

FIG. 6 is the snapshot of a webpage;

FIG. 7 is an exemplary block diagram illustrating an exemplary segment tree of the webpage depicted in FIG. 6;

FIG. 8 is an exemplary textual representation of an algorithm of detecting UOIs from a Web page, according to another aspect of the invention;

FIG. 9 is a block diagram illustrating an exemplary process of UOI identification and detection, including UOI annotation and merging rules;

FIG. 10 is a block diagram illustrating an exemplary content adaptation process through a UOI-based segment tree, according to another aspect of the invention;

FIG. 11 is a snapshot diagram illustrating an exemplary comparison of visualization effect from three websites;

FIG. 12 is a diagram of the hierarchical semantic meta model of the present invention;

FIG. 13 is a diagram of the HTML semantic ontology of the present invention;

FIG. 14 is a diagram of the four-step process of the present invention to automatically identify and detect semantic HTML segments;

FIG. 15 is a diagram of the CSS processing algorithm of the present invention;

FIG. 16 is a textual representation of the present invention's content pattern matcher algorithm in Java-style pseudo-code;

FIG. 17 is a diagram of the content structure identification algorithm of the present invention; and

FIG. 18 is a diagram of the semantic segment detection algorithm of the present invention.

### DETAILED DESCRIPTION OF THE INVENTION

Generally, the present invention provides a method and system for analyzing, processing, and displaying websites. This method and system is directed specifically towards handheld or mobile devices which possess limited display and processing capabilities, and therefore are frequently unable to display webpages as they would appear on full-sized computers.

The present invention includes several algorithms and accompanying computer systems which implement them. The algorithms of the present invention take several approaches to the analysis and processing of webpage data in order to preserve the logical and semantic integrity of the page when displaying it on a handheld or mobile device.

The algorithms of the present invention employ both syntax-based and semantic-based approaches to the analysis of webpage information, as will be described herein.

The method and system of the present invention can be employed in a variety of contexts. For instance, the present invention can be employed independently on a singular handheld or mobile device. In such a scenario, the device will perform the analysis and processing and described herein. Alternatively, the present invention can also be employed on an external device (such as a webserver), to which the handheld or mobile device would connect. In this embodiment, the analysis and processing of the present invention would occur on this external device, relieving the handheld device from this processing load.

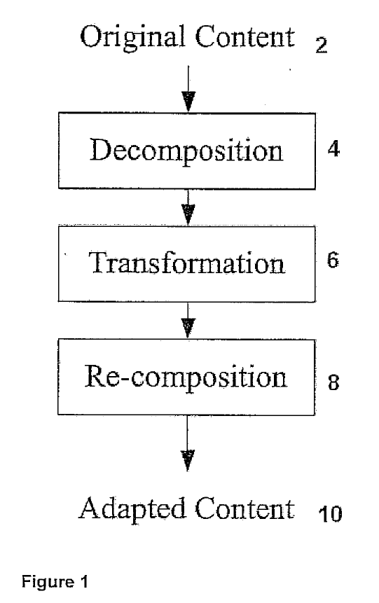

FIG. 1 is a flow chart illustrating exemplary phases of a dynamic content adaptation process, according to one aspect of the present invention. As shown in FIG. 1, one example of content adaptation may comprise a three phase process to transform the original Web content (2) into adapted content (10). These phases are: decomposition (4), transformation (6), and re-composition (8). In the decomposition phase (4), the original Web page (2) is structurally parsed and decomposed into components based on a predefined content model. Both the layout and constituent elements (for example, text, image, audio, and video) are extracted separately in this phase. In the transformation phase (6), transcoding approaches are used to change the fidelity and/or modality of the extracted components for better representation on target (receiving) devices. In the re-composition phase (8), the presentation styles (layouts) and the adapted components are reorganized and recomposed into the final adapted contents (10) to be delivered to the receiving devices.

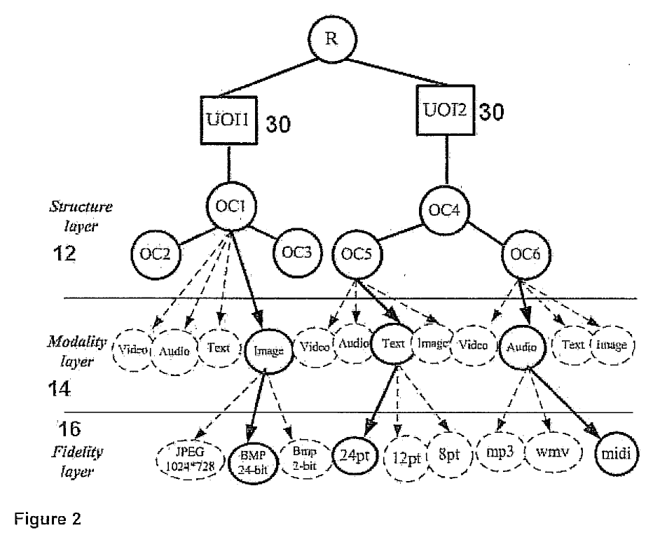

FIG. 2 is a block diagram illustrating an exemplary hierarchical representation of content structure model, according to another aspect of the present invention. The requirement of maintaining semantic consistency (‘semantic consistency’ refers to logical or intuitive relationships between pieces of information which necessitates their portrayal in a specific way, such as being grouped together, next to one another, or in a sequence) in the process of content adaptation is formalized into an isomorphism problem: the relationships among objects and formed groups prior to and after adaptation should be able to be expressed by an isomorphic graph. To solve this problem, a layered content structure model is used to organize objects with possible presentation options of a given Web page. As shown in FIG. 2, a content structure model maintains available adaptation rules and possibilities for individual presentation objects. According to the content structure model, Web content is organized in a three-layer structure: structure layer (12), modality layer (14), and fidelity layer (16). The structural layer (12) comprises the presentation objects contained in the content; the modality layer (14) comprises possible presentation types for each object; the fidelity layer (16) further specifies possible presentation formats for each presentation type.

The content structure model is further extended by incorporating object relations into its structure layer, according to another aspect of the present invention. The goal is to maintain semantic consistency (‘semantic consistency’ refers to logical or intuitive relationships between pieces of information which necessitates their portrayal in a specific way, such as being grouped together, next to one another, or in a sequence) among objects in layout re-arrangement to enable more elaborate content adaptation under various circumstances and contexts.

As shown in FIG. 2, an atomic information unit, also referred to as Unit of Information (UOI) (30), is defined as a semantic unit comprising a set of segments and media objects that have to be presented together on the same screen. UOI can be viewed as the basic presentation unit of Web content. In other words, a Web page can be presented as a composition of multiple UOIs. In the content structure model, a composition of UOIs is an expression in the structure layer. The aim of UOI is to preserve the semantic coherence of Web content throughout adaptation processes. In the preferred embodiment, UOIs are identified in the decomposition phase; in the subsequent transformation and composition phases the UOIs are retained unbroken.

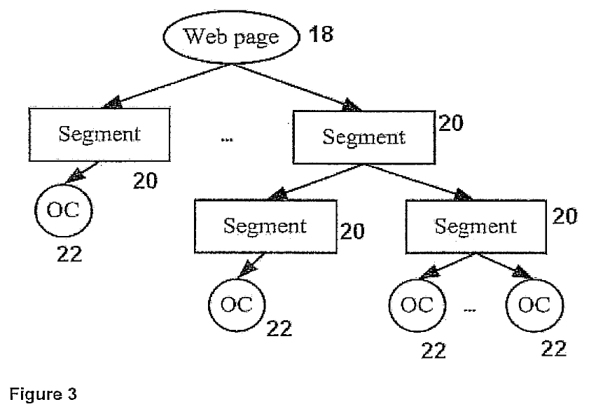

FIG. 3 is an exemplary block diagram illustrating the relationships between Web pages (18), segments (20), and object clusters (22), according to another aspect of the present invention. A UOI contains two types of elements: segments (20) and object clusters (OCs) (22). To design a Web page content in a markup language (such as HTML), authors typically use various partition elements (for example, HTML tags such as <frameset>, <table>, and <div>) to arrange the layout of information presentation objects. These partition elements contain information regarding layout arrangements and relationships between various content items. Each of these partition elements is called a segment (20). Based on this approach, a Web page can be decomposed into a set of segments organized in a hierarchical structure, as shown in FIG. 3. This type of tree-like structure of segments is called a segment tree.

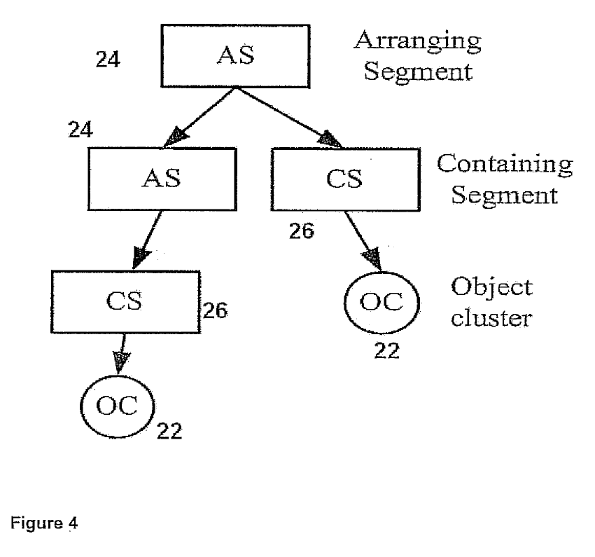

FIG. 4 is an exemplary block diagram illustrating a hierarchical representation of a segment tree, according to another aspect of the present invention. Segments can be further classified into two types: arranging segment (AS) (24) and containing segment (CS) (26). FIG. 4 is a segment tree that illustrates the concepts and relationships between AS (24), CS (26), and OC (22). The present invention constructs a segment tree in order to detect UOIs in a Web page. An AS represents a partition element that comprises no concrete media objects as direct children. It is used to define the layout of a specific portion of a Web page. In contrast, a CS represents a partition element that comprises at least one concrete media object as a child.

All media objects contained in a Web page are further classified into different object clusters based on their types. In the preferred embodiment, one exemplary object cluster system can comprise four categories: text, image, audio, and video. After a parsing process, the presentation components are identified as “objects” associating with presentation attributes. In the preferred embodiment, the objects with the same attributes (for example, modality) can have the same semantic hierarchies. An object cluster (22) is thus defined as a collection of media objects that possess the same modality inside of the same containing segment (CS). As an example, in the preferred embodiment, six types of object clusters may be identified: text cluster (TC) (for example, text objects), still image cluster (SIC) (for example, .jpg, .bmp, .tiff, and .gif objects), video cluster (VC) (for example, .avi, .wmv, and .mpg objects), dynamic image cluster (DIC) (for example, .png and .gif objects), flash cluster (FC) (for example, .swf objects), and audio cluster (AC) (for example, .mp3 and .wav objects). It should be noted that the present invention is not limited to the precise exemplary embodiments detailed above, and that various other changes and modifications may be made by one skilled in the art.

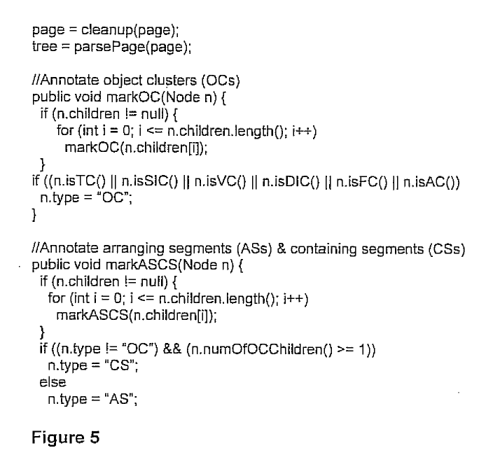

FIG. 5 is an exemplary textual representation of a pseudo-code algorithm (in the style of Java programming language) of constructing a segment tree, according to another aspect of the invention. The step of constructing a segment tree comprises constructing a content structure model (CSM), traversing the CSM, annotating object clusters, annotating segments, and transforming the content tree into a segment tree.

HTML provides great flexibility to integrate a variety of multimedia types; however, its allowing free style writing makes it hard to identify and determine various types of objects in an HTML document. In order to overcome this problem, the present invention transforms the content into a well-formed format.

Then the well-formed HTML page is parsed into a tree-like structure, each node representing an HTML tag in the page. In theory, any eXtensible Markup Language (XML) parser could be used to parse the HTML content. In the preferred embodiment, the generated tree structure (segment tree) is traversed for searching object clusters. According to the six exemplary types of object clusters, file extensions are used to identify object clusters. Take the following tag as an example:

<img src=http://news/peace.jpg width=“50”>

The tag node is considered as a still image cluster (SIC) due to its file extension “.jpg.” In alternative embodiments, any tree traversal algorithm can be used. In the preferred embodiment, a recursive post-order traversal algorithm is adopted, where each node is visited after all of its children nodes are visited.

After all object clusters are annotated, the present invention traverses the segment tree once again to identify containing segments and arranging segments. For example:

<li id=“82”>

<a href=27>

<img src=“http://news/peace.jpg” width=“” height=“21”/>
Holiday wreath sparks controversy

</a>

</li>

Here, the “image” segment has been annotated as an object cluster in the previous step. Its enclosing segment “a href” contains an object cluster; therefore, the enclosing segment is marked as a containing segment. The outmost segment “li” only has one containing segment as a direct child; therefore, it is marked as an arranging segment.

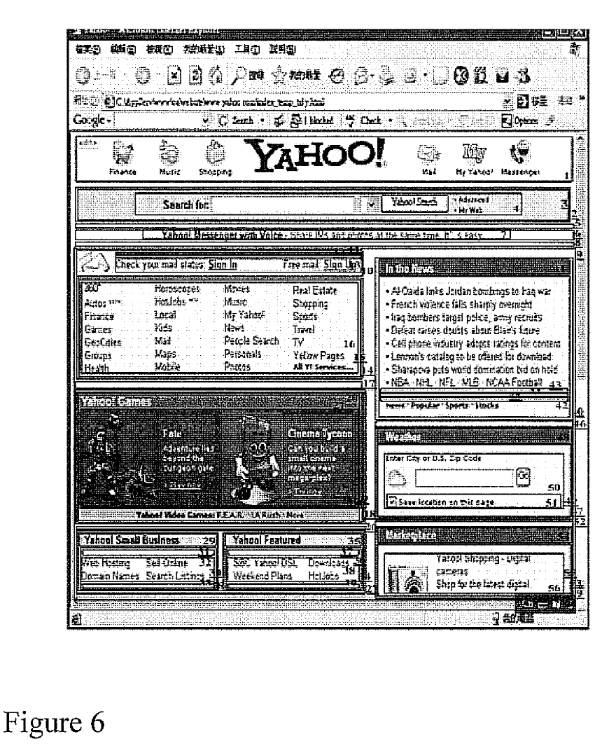

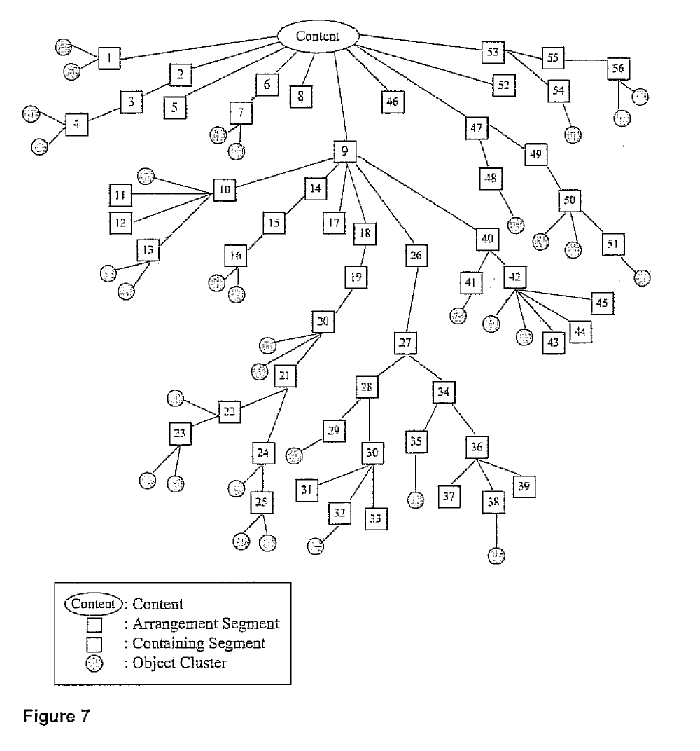

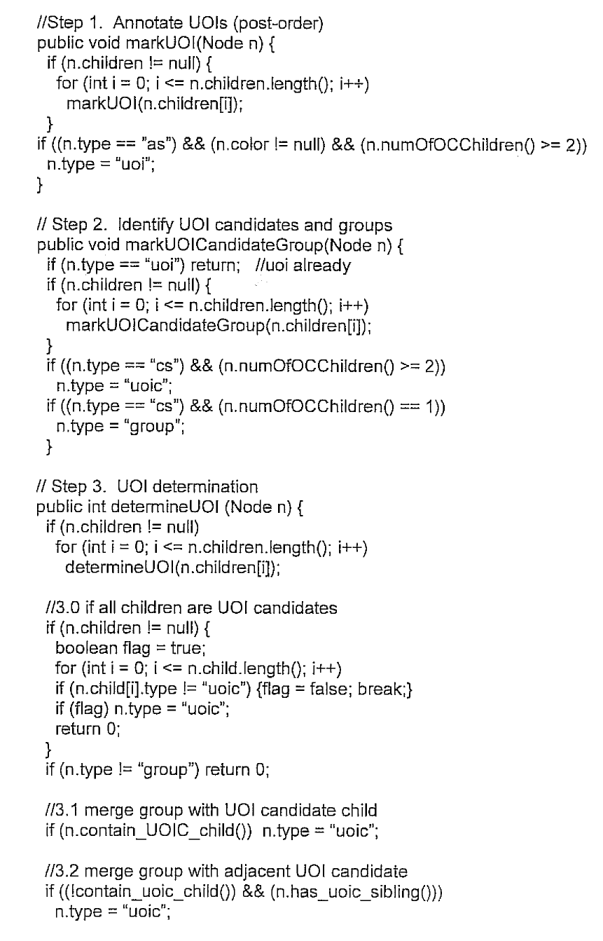

FIG. 7 is an exemplary block diagram illustrating an exemplary segment tree created for the snapshot of the Web page shown in FIG. 6. The result of this construction algorithm to an exemplary Yahoo Web page (FIG. 6) is a segment tree as shown in FIG. 7, each node being annotated as one of the three categories: OC, CS, or AS. The next step is to identify and detect UOIs in the segment tree.

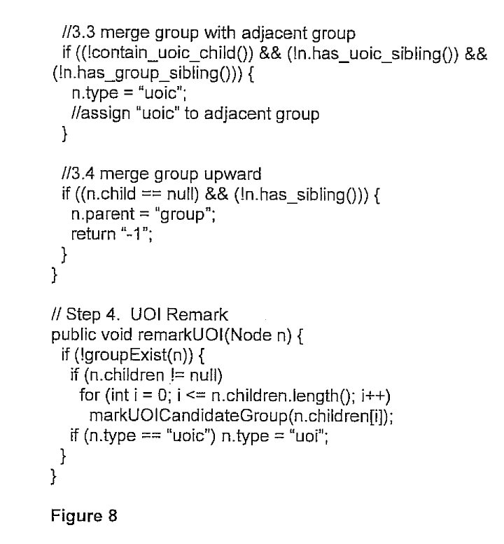

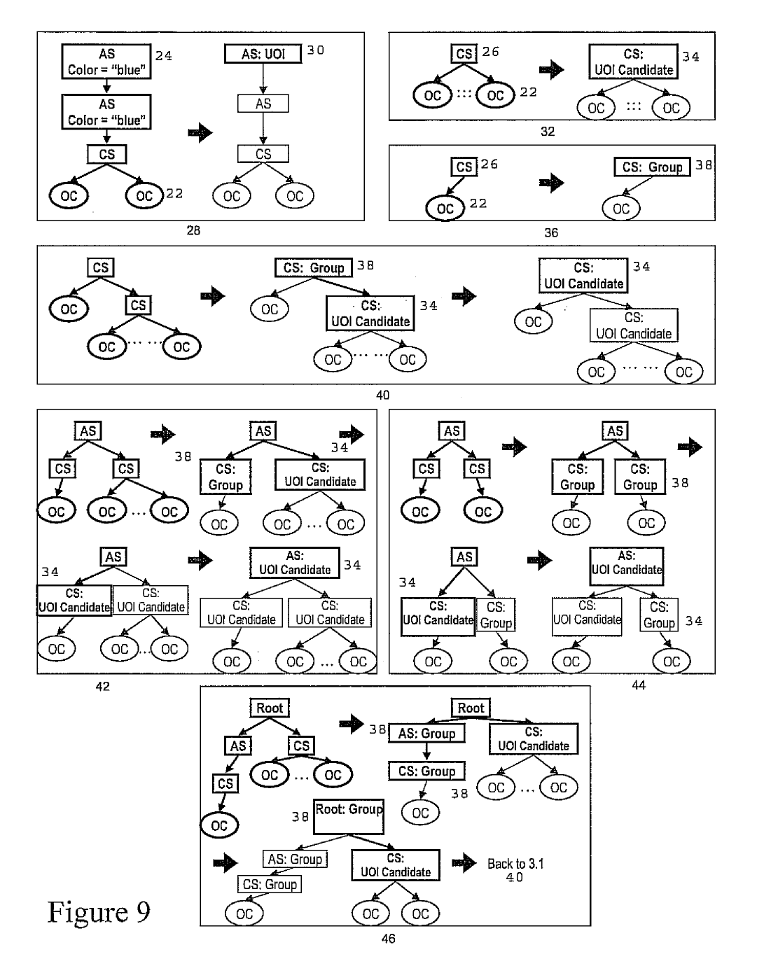

FIG. 8 is an exemplary textual representation of a pseudo algorithm (in the style of Java programming language) for detecting UOIs from a Web page, according to another aspect of the present invention. To ease explanation, FIG. 9 is a block diagram illustrating an exemplary process of UOI identification and detection, including UOI annotation and merging rules. It should be noted that the invention is not limited to the precise exemplary embodiments detailed above, and that various other changes and modifications may be made by one skilled in the art.

The algorithm follows a two-phase process: the first phase traverses the initial segment tree and annotates an initial set of UOIs (Step 1); the second phase traverses the result segment tree from phase 1 to further identify all possible UOIs (Step 2˜Step 4).

In Step 1, the initial segment tree is recursively traversed in post-order to identify all UOIs. As shown at (28), a segment node is annotated as a UOI (30) if it meets all three conditions: its type is AS (24); it has been annotated with a color attribute; and it contains at least two OC children (22).

Step 2 identifies UOI candidates and Groups in a segment tree. As shown at (32), a segment is marked as a UOI candidate (34) if it meets two conditions: the segment type is CS (26); and the segment contains at least two OC children (22). As shown at (36), a segment is marked as a Group (38) if it meets two conditions: the segment type is CS (26); and the segment contains only one OC child (22).

Step 3 deduces more UOIs by merging UOI candidates and Groups in the result segment tree in four ways. In Step 3.1, as shown at (40), if a Group (38) contains a UOI candidate (34) as a child, it merges with its UOI candidate child to form a new UOI candidate (34). In Step 3.2, as shown at (42), if a Group (38) contains no UOI candidate children but has an adjacent UOI candidate sibling (34), it merges with the UOI candidate sibling to form a new UOI candidate (34). If the newly-formed UOI candidate has no siblings, it is further merged with its parent to form a new UOI candidate (34). This process may be recursively repeated toward the root of the tree. In Step 3.3, as shown at (44), if a Group (38) has neither UOI candidate children nor siblings but has an adjacent Group sibling (38), it merges with its adjacent Group sibling to form a new UOI candidate (34). If the newly-formed UOI candidate (34) has no siblings, it is further merged with its parent to form another UOI candidate (34). Again this process may be recursively repeated toward the root of the tree. In Step 3.4, at (46), if a Group (38) does not have any child or sibling, it is merged with its parent (38) to form a new Group (38), and the process goes back to Step 3.1.

Finally, Step 4 cleans up the resulting segment tree. If no Group exists in the segment tree, all UOI candidates are marked as UOIs.

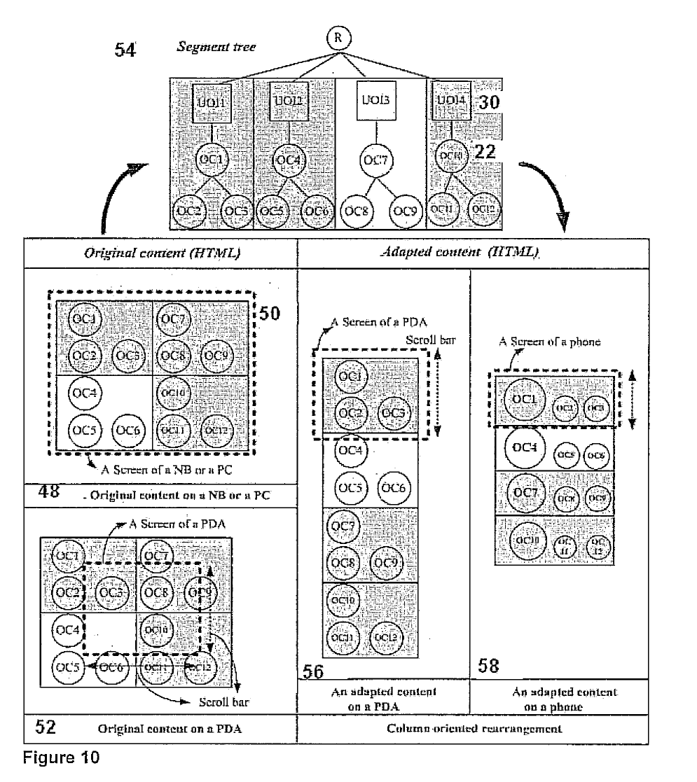

FIG. 10 is a block diagram illustrating an exemplary content adaptation process through a UOI-based segment tree, according to another aspect of the present invention. The aforementioned algorithm of the present invention, depicted in FIG. 9, helps to automatically detect all UOIs of a Web page. Through this process, a segment tree is constructed and annotated by UOIs, which can be used to generate the final adapted content (for example, in HTML format).

(48) shows the original content designed for PC or Notebook (NB), which contains 12 information objects (OC1 to OC12) (50), far greater than a PDA's display capabilities. As shown at (52) a PDA may only present 3 full units (OC3, OC8, and OC10) and part of one unit (OC9). A user must scroll throughout the page in order to display the entire page content. Therefore, the original content (in HTML) is transformed into a segment tree as shown at (54), by extracting UOIs (30) containing content objects (22) and segments.

After UOI detection and evaluation, the nodes in the segment tree are reorganized under corresponding UOI nodes. As shown at (54) four UOIs are identified and include all presentation units. For example, UOI1 contains the three units in the upper left-hand section of the original design at (48): OC1, OC2, and OC3. Afterwards, if each UOI fits on the PDA's screen, then their locations are rearranged through column-oriented rearrangement, as shown at (56). The original multi-column layout is changed into a single-column layout.

If the largest size of the UOIs in the content cannot fit into a small-size screen like a wireless phone, the scales and positions of the objects in the UOI should be further adjusted for a suitable presentation. Note that the objects residing in the same UOI may implicate some layout relationships (e.g., parallel and serial) among them. As shown at (56), OC3 should be presented right of OC2 (parallel); OC2 should be presented after OC1 (serial). Layout adaptation should maintain these implicit relationships. As shown at (58), to keep an entire UOI into one screen, the layout positions between containing objects are adjusted: OC2 and OC3 are changed to be parallel with OC1 with reduced sizes (by changing their size attributes). Thus, their implicit inter-relationships are still maintained.

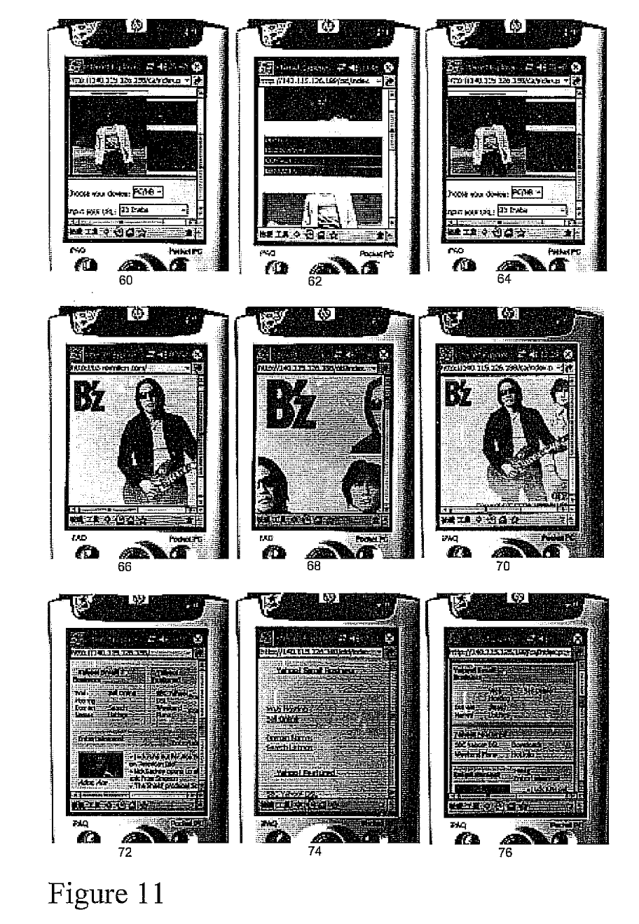

FIG. 11 is a snapshot diagram illustrating an exemplary comparison of visualization effect from three websites: Inaba (60, 62, 64) and Tak (66, 68, 70) are websites featuring two Japanese musicians, Koshi Inaba (vocal) and Tak Matsumoto (guitar), who formed a band called B'z (http://bz-vermillion.com/). (72, 74, 76) portray the Yahoo website; without adaptation (72), with primitive column-wise adaptation (74), and with UOI-based adaptation (76). It shows the visualized results on PDAs applying different strategies on three randomly selected websites (Inaba, Tak, and Yahoo) either focusing on images or on texts. The experimental results for each website occupy one row, which comprises three screen shots: original content, adapted content without UOI detection, and adapted content based on UOI detection. As shown in FIG. 11, content adaptation based on the present invention's UOI detection algorithm effectively reorganizes and adjusts the original content on a PDA screen.

Some websites emphasize on image-oriented content, for example, Inaba and Tak as shown in (60, 62, 64) and (66, 68, 70), respectively. Using the primitive column-wise approach, each object is treated independently. Thus, the adaptation process may scale up one image object to the entire screen size. Moreover, some unrelated information objects may be integrated into one screen, as shown in (62) and (68). This simple object-based adaptation apparently may cause confusing representation. In contrast, by applying the UOI detection algorithm of the present invention, the original semantic meanings associated with objects are preserved in the process of content adaptation. As shown in (64) and (70), original large images are scaled down to fit into the PDA screen, associated with related information.

Some websites emphasize text-oriented content, as shown by Yahoo at (72). Using the primitive column-wise approach, each information object (mostly text-oriented objects) is adapted based on delivery context. However, the presentation sequence of the adapted objects may become ambiguous, as shown at (74). By using the UOI detection algorithm of the present invention, the related information objects are grouped as an integral presenting unit as shown at (76). Thus, the semantic relationships between information objects are preserved.

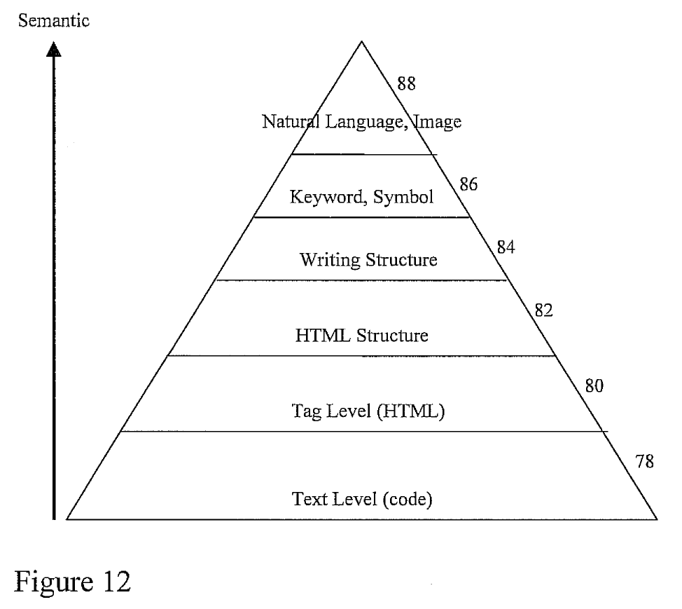

The present invention further includes an additional method for analyzing, processing, and displaying webpages on handheld devices. This method is based in part on characterizing electronic information within a hierarchical semantic meta model, as shown in FIG. 12. The first and most basic semantic level is the text level (78). Before content or data can be processed, the text elements must satisfy semantic requirements of the specific code or language. The second semantic level is the tag level (80). HTML is a semistructured programming language whose code structure is delimited by a set of predefined HTML tags. The third semantic level is the HTML structure level (82). Many HTML tags have embedded semantic meanings so that they can depict the hierarchical structure of an HTML page. For example, the HTML tag <li> can be used to list a set of items. The fourth semantic level is the writing structure level (84). Different types of web content may imply a common writing pattern. For example, an article typically comprises a title followed by multiple sections. The fifth level is the keyword and symbol level (86). Semantically related HTML sections may share common keywords or symbols. For example, an article introducing a scientist typically may have his/her name shown in both the body of the article and in the caption of his/her picture. The sixth semantic level is the natural language and image level (88). Language itself may provide more hints to expose the original semantic intention of the page developers. For example, synonyms may help in detecting semantic relationships between sections. When analyzed properly, each semantic level reveals information about the semantic meaning and intended visual presentation of the specific web content. The present invention includes an algorithm and technique corresponding to each semantic level to extract semantic meanings among segments.

In order to properly detect the hierarchy of semantic units present in a given webpage, it is necessary to establish a system of atomic semantic units oriented to HTML documents. An HTML document can be thus deconstructed into a synergetic combination of these units. HTML grammar provides a rich set of tags with implicit semantic meanings to define content structure. In other words, analyzing HTML tags and structures can often help in extracting and eliciting semantic meanings intended by the original page developers. For example, the HTML tag <p> represents a paragraph; <ol>, <ul>, and <li> may present an ordered or unordered list in an HTML document. Thus, behind HTML syntax is its implicit semantic language. For this reason, the present invention formally classifies various HTML tags (syntax units) into a set of categories (semantic units), based on their implicit semantic meanings. The structure of an HTML document can thus be analyzed by the present invention from the perspective of semantics.

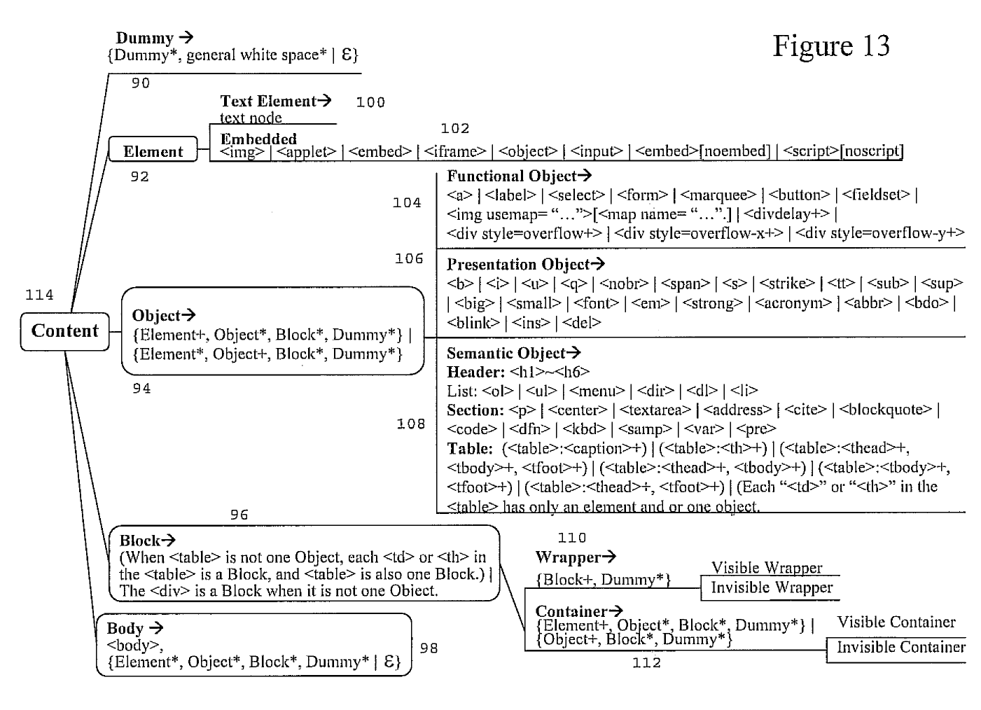

The present invention further establishes an ontology for HTML semantic units. As shown in FIG. 13, an HTML document contains five fundamental categories of semantic units: dummy (90), element (92), object (94), block (96), and body (98). These units have self contained relationships between them. For example, an object can be constructed using elements; a body can be constructed using elements, objects, blocks, and dummy. Element (92) is defined as a basic semantic member of an HTML document. An element in turn is divided into text element (100) and embedded element (102), the former referring to textual data and the latter referring to multimedia elements inserted in a webpage. An Object refers to a container encompassing elements or other objects that have the same function, purpose, or presentation style. An object is in turn divided into functional object (104), presentation object (106), and semantic object (108). They refer to sections encapsulating functions (e.g., anchoring), presentation styles, and structural relationships, respectively. Dummy (90) does not represent any actual presentation data in a Web page (e.g., whitespaces). A Block (96) delimits and arranges components in a Web page. Blocks can be further classified into two types: wrapper (110) and container (112), depending on whether they contain actual display materials. Body (98) of an HTML document comprises the overall information of the document. Finally, content (114) represents the entrance (root) of an entire HTML document.

In the preferred embodiment, a BNF form is used to formally define each semantic unit. As an example, text element refers to a text node in an HTML document. Composed of characters, a text node may refer to a word, a symbol, a sentence, or a section contained in an HTML tag. For example:

text_element := text_node
text_node := char+ | <html_tag> char+ </html_tag> |
<html_tag> char+

These are two examples of text elements:

<body>
<b>Good morning</b>
</body>

The text node is “Good morning.”

<body>
<li>Traffic regulations
</body>

The text node is “Traffic regulations.”

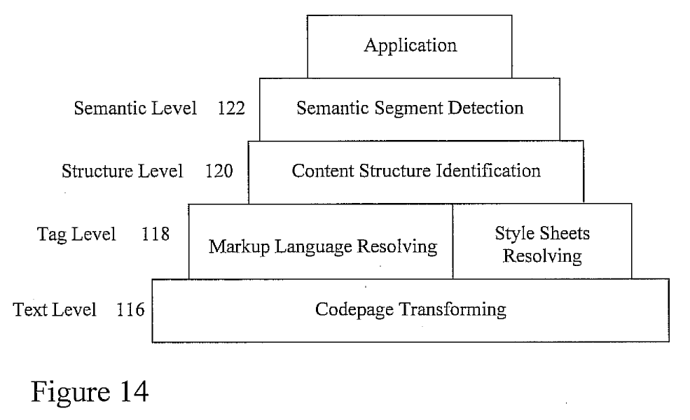

Based on the formalization of HTML semantic units, the present invention follows a stepwise procedure and method to automatically identify and detect semantic segments in an HTML document. The process comprises four steps as shown in FIG. 14: codepage transforming (116), CSS localizing and HTML parsing (118), content structure identification (120), and semantic segment detection (122).

Before analyzing a downloaded Web page, the present invention first performs a preprocessing step, since the characters of the document are typically encoded as a sequence of types according to a particular character encoding when transmitted over the Web (HTML was designed to support different coding pages). The encoding may be either in a Unicode Transformation Format (e.g., UTF-8) that directly encodes unicode characters, or in a legacy encoding (e.g., Windows-1252) that does not. In both scenarios, the present invention transforms the receiving bytes into a homogeneous format for further analysis and processing.

The present invention then continues with the application of an encoding and conversion algorithm is as follows. First, the present invention detects the character encoding of the downloaded content. Second, it transforms the content into metacontent represented by Unicode. Then, the present invention performs content adaptation based on the obtained Unicode. Finally, the present invention transforms the adapted meta-content back into the original “character encoding” content.

Content structure identification (120) requires the consideration of presentation features and the display position of a tag. In HTML, these features could be specified in two ways, either inside of the corresponding HTML document as tag attributes (e.g., “<table bgcolor=black>”) or via separate CSS documents. CSS provides selectors to describe presentation features with patterns for HTML tags. Note that CSS specifications could be embedded inside of an HTML document as a simplified version. Take the following segment of CSS specification as an example.

<STYLE>
<!-- body { color: red }
p{ color: blue } -->
</STYLE>
<BODY>

This is anonymous text before the P.

<P>This is the content of P.</P>
This is anonymous text after the P.
</BODY>

In this example, the presentation features are specified in tag <style> in a CSS-embedded manner. As shown above, the body of the document should be rendered in red, except blue within the tag of <p>.

Many existing HTML pages adopt CSS to specify their style specifications. Therefore, to properly understand the structure and presentation semantics of an HTML document, the present invention extracts its corresponding CSS definitions for examination. In other words, the present invention detects the presentation features for each tag. It should be noted that typically, the style information of CSS and inheritance are not located together with the content.

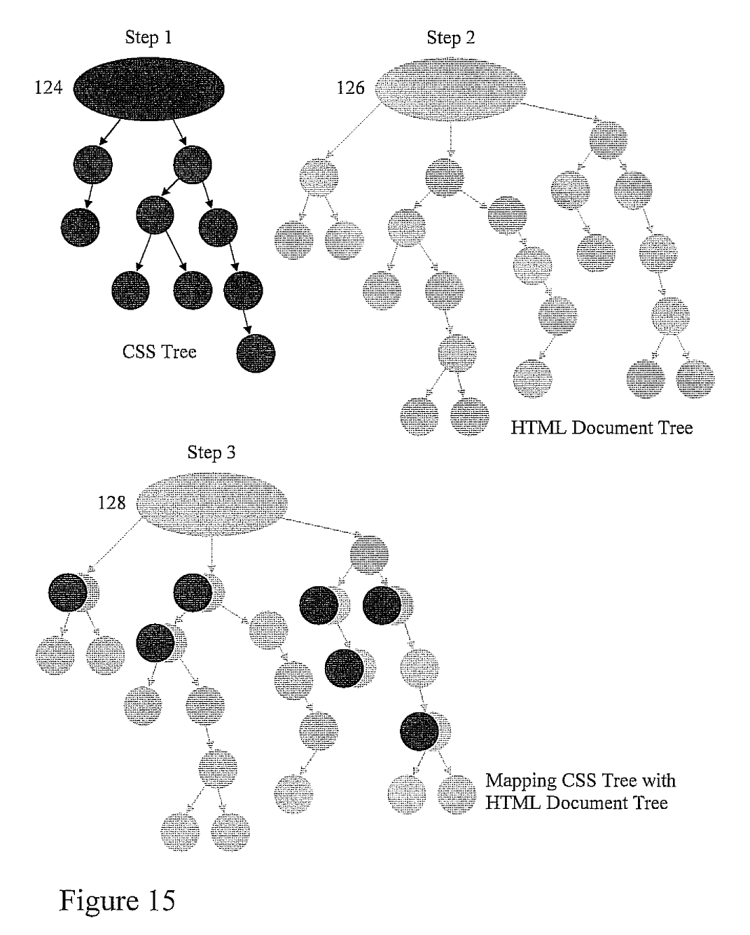

The present invention further includes a CSS-enabled page parsing algorithm, as depicted in FIG. 15. In the preferred embodiment, CSS specification and inheritance information are automatically located and extracted at the HTML tag level. The style specification for every HTML tag is extracted from the associated CSS documents and attached to the tag. In the preferred embodiment, the input of this transformation is HTML Unicode text; the output is a CSS-annotated HTML tag tree.

The present invention searches the input HTML text and locates CSS and inheritance information. Then, the system parses the CSS document and builds a CSS tree (124), as shown in FIG. 15. Afterwards, the system parses the HTML document and builds an HTML tag tree (126). Finally, the system maps the CSS tree with the HTML tag tree (128). Note that in the preferred embodiment the attachment has a plug-in relationship; so that the CSS information can be dynamically updated or removed from the HTML document tree.

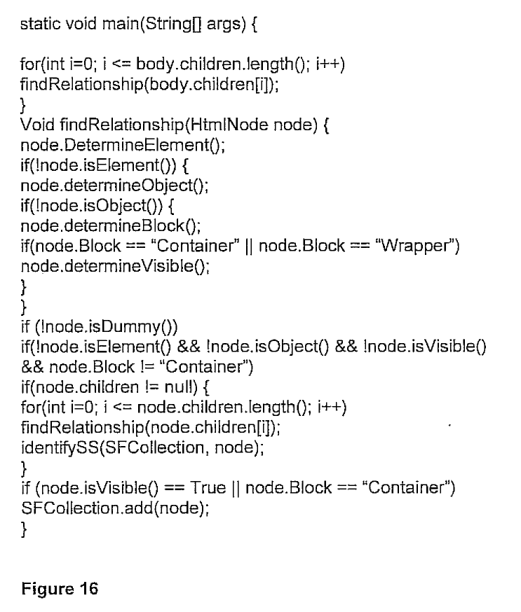

The present invention further includes an algorithm for detecting structural segments, by identifying the semantic units defined in FIG. 13. This algorithm, termed ‘content pattern matcher,’ is presented in a Java-style pseudo code in FIG. 16.

In the preferred embodiment, the present invention employs a depth-first search strategy to traverse the structure tree. If a tag is not <Body>, the system checks whether it is a dummy, an element, or an object. Otherwise, the system moves to its next sibling tag. If the tag contains visible display information or if it is a container, it can determine that the tag is a structure fragment. Otherwise, the system keeps on moving to the next tag. If a tag is <Body>, it checks whether it is a dummy. If it is, the system moves to the next sibling tag. Otherwise, it checks whether it is an element or an object. If it is, the tag is a structure fragment.

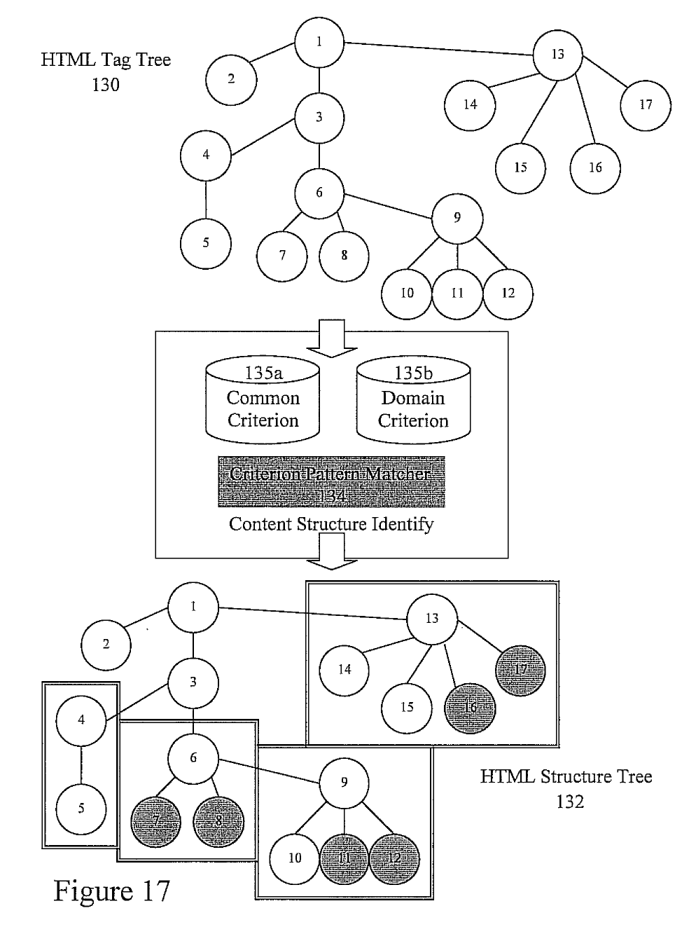

As shown in FIG. 17, the content pattern matcher algorithm (134) transforms an HTML tag tree (130) into an HTML structure tree (132). Note that the algorithm makes judgments based on the traditional HTML structure patterns and criteria (135a) defined in HTML specifications (e.g., tags for arrangement and vision style). In the preferred embodiment, domain criteria (135b) may be needed to support heterogeneous domain-specific features (e.g., local linguistic habits).

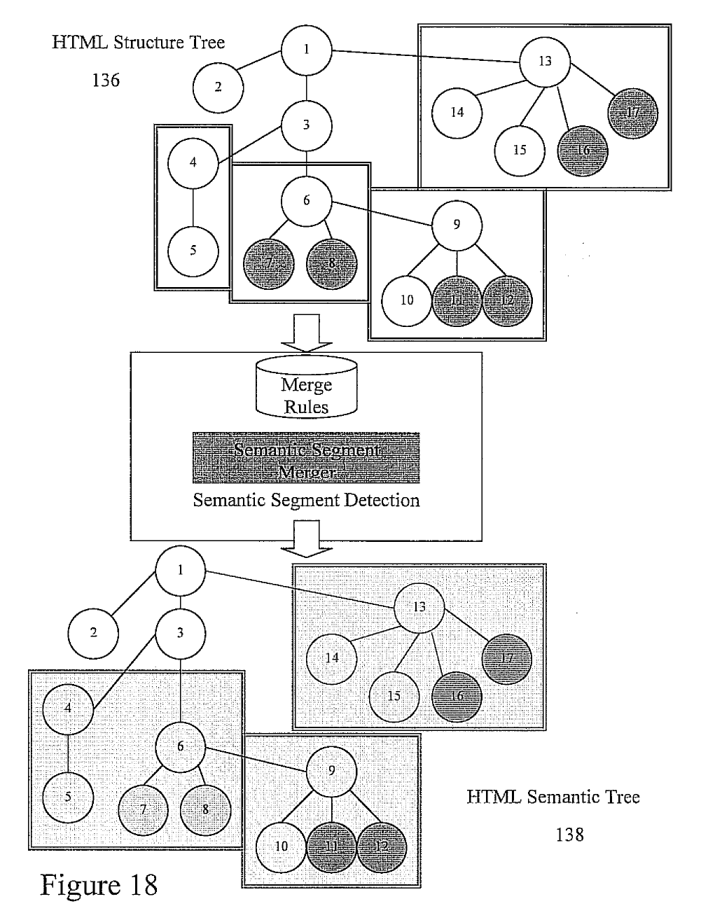

Finally, the present invention determines semantic segments based on the generated structure tree. This is accomplished by deciding which parts (sub-trees) of the structure tree possesses self-contained semantic meanings. In the preferred embodiment, a semantic segment must have one or more of the four important properties: complete function (functionality related), readable typesetting (readability related), relationship of presenting (space and time related), and literary context (semantics related). The present invention further includes a merging algorithm to extract semantic segments from structural fragments obtained from the structure tree. A conceptual depiction of this algorithm is shown in FIG. 18.

The algorithm first decides which parts of a structure tree can become candidates for semantic segments. These are known as semantic fragments (136). In the preferred embodiment, the candidate selection algorithm is based on visual effects of corresponding HTML representation. The process continues until all semantic fragments are decided. The key criterion of the algorithm is how to merge semantic fragments and add structural units, objects, elements, and blocks into a semantic segment. In the preferred embodiment, three guidelines are used. First, a semantic segment must retain the integrity of functionality. Second, a semantic segment must retain the readability of article and vision. Third, objects in a semantic segment must retain temporal and spatial stratum. In the preferred embodiment, the selected semantic fragments are then converted into semantic segments (138).

The present invention further includes a system whereby the analysis of the webpages for presentation by the mobile device also takes into account circumstantial factors associated with the user. For instance, the present invention can detect if the sound on the user's device is muted, or if the device lacks the proper software or plugin to play a web video. In such cases, the present invention will determine that a sound or video file present on a webpage accessed by the user need not be downloaded. This functionality increases the device's efficiency by eliminating unnecessary bandwidth usage, and also improves the presentation of data on the device.

A variety of techniques, utilizing dedicated hardware, general purpose processors, software, or a combination thereof may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

The present invention can also be employed on a Web server, interpreting and transmitting each webpage based on the limitations of the requesting device. Alternatively, the invention can be employed on the end user's handheld device, processing each website locally in the manner outlined above.

At present, it is believed that the preferred implementation will make substantial use of software running on a general-purpose computer or workstation. Such an implementation might employ, for example, a processor, a memory, and an input and/or output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor, memory, and input and/or output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory), magnetic tape, a removable computer diskette (for example, media), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards, displays, pointing devices, and the like) can be coupled to the system either directly (such as via bus) or through intervening I/O controllers (omitted for clarity).

Network adapters such as network interface may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, supporting adaptation capability of a presentation module.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for intelligently adapting internet content for display on handheld devices comprising the steps of: analyzing internet content, processing the analyzed content, and presenting the processed content in a logical and coherent fashion.

2. A method for intelligently adapting internet content for display on handheld devices comprising the steps of: analyzing internet content, processing the analyzed content based on syntax-related factors, and presenting the processed content in a logical and coherent fashion.

3. The method of claim 2, wherein said analyzing step includes organizing internet content based on a layered content structure model.

4. The method of claim 3, wherein said content structure model includes a structure layer, a modality layer, and a fidelity layer.

5. The method of claim 2, wherein said analyzing step further includes parsing internet content to define arranging segments, containing segments, and object clusters.

6. The method of claim 2, wherein said processing step includes the step of constructing a segment tree.

7. The method of claim 6, wherein said constructing step includes the steps of: constructing a content structure model, traversing the content structure model, annotating object clusters, annotating segments, and transforming content into a segment tree.

8. The method of claim 6, wherein said constructing step is further defined as transforming internet content into a well-formed format.

9. The method of claim 7, wherein said traversing step includes a recursive traversal algorithm.

10. The method of claim 2, wherein said processing step further includes the identification and detection of Unit-Of-Information (UOI) elements.

11. The method of claim 2, wherein said processing step further includes the steps of: traversing a segment tree to identify UOIs, identifying UOI candidates and groups, merging UOI candidates and groups, and cleaning up the resulting segment tree.

12. The method of claim 2, wherein said presenting step includes the step of generating adapted internet content.

13. The method of claim 2, wherein said presenting step further includes the step of reorganizing UOIs based on their original location.

14. The method of claim 2, wherein said presenting step further includes the step of rearranging the UOI's location to conform to the display limitations of the device.

15. The method of claim 2, wherein said presenting step further includes the steps of scaling and modifying the size and position of the UOIs to display properly on the device.

16. The method of claim 2, wherein said presenting step further includes the step of maintaining the layout relationship between different UOIs.

17. A method for intelligently adapting internet content for display on handheld devices comprising the steps of: analyzing internet content, processing the analyzed content based on semantic-related factors, and presenting the processed content in a logical and coherent fashion.

18. The method of claim 17, wherein said analyzing step includes the step of characterizing internet content based on a hierarchical semantic meta model.

19. The method of claim 17, wherein said analyzing step further includes the step of deconstructing an HTML document into a combination of atomic semantic units.

20. The method of claim 19, wherein said deconstructing step further includes classifying syntax units into a set of semantic units based upon the syntax unit's implicit semantic meanings.

21. The method of claim 17, wherein said analyzing step further includes the step of formally defining each semantic unit.

22. The method of claim 17, wherein said processing step includes the steps of: codepage transforming, markup language and stylesheet resolving, content structure identifying, and semantic segment detecting.

23. The method of claim 17, wherein said processing step further includes locating and extracting stylesheet information at the HTML tag level.

24. The method of claim 17, wherein said processing step further includes the steps of: parsing the stylesheet document, building a stylesheet tree, parsing the HTML document, building an HTML tag tree, and mapping the stylesheet tree with the HTML tag tree.

25. The method of claim 17, wherein said processing step further includes the step of: traversing the structure tree to detect structural segments.

26. The method of claim 17, wherein said presenting step includes the step of transforming an HTML tag tree into an HTML structure tree.

27. The method of claim 26, wherein said transforming step considers traditional HTML criteria as well as domain criteria.

28. The method of claim 17, wherein said presenting step further includes determining semantic segments based on the generated structure tree, and extracting semantic segments from the structure tree.

29. The method of claim 17, wherein said presenting step further includes merging the defined semantic segments based on a series of criteria.

30. The method of claim 29, wherein said criteria include but are not limited to: functionality, readability, and temporal and spatial stratum.

31. The method of claim 1, further including the step of accounting for the users circumstantial factors.

32. A system and accompanying software program for enabling the method steps of claim 1.

33. The system of claim 32, configured to operate on a central webserver.

34. The system of claim 32, configured to operate on a local handheld device.
